(19) United States
(12) Patent Application Publication
(10) Pub. No.: US 2019/0384225 A1
(43) Pub. Date: Dec. 19, 2019

(54) MULTIFUNCTIONAL TIMEPIECE WITH LED ILLUMINATING SYSTEM

(71) Applicant: TSUEN JER ENTERPRISE CO., LTD., Taipei City (TW)

(72) Inventor: CHENG-WEI LIN, TAIPEI CITY (TW)

(21) Appl. No.: 16/010,946

(22) Filed: Jun. 18, 2018

(51) Int. Cl. G04B 19/30; G04B 47/06; G04B 19/04

(52) U.S. Cl. CPC G04B 19/30; G04B 19/04; G04B 47/068

(57) ABSTRACT

A multifunctional timepiece with LED illuminating system mainly includes a case frame, a movement, a set of hands, a dial, a main body of the timepiece, a set of LED lights, a light transmissible plate, a power supply and a control device. The LED lights are fixed to a circumferential edge of the light transmissible plate; the light transmissible plate is located above the dial, the hands are located above the light transmissible plate, and the light transmissible plate is provided with markers, which are consistent with those provided on the dial. The set of LED lights includes at least three LED lights, which are equally spaced and electrically connected to a set of wires in series or in parallel. The control device can be a photosensitive control element or a manual control switch. The timepiece can further include a thermometer and a hygrometer located within the case frame.

### FIELD OF THE INVENTION

The present invention relates to a timepiece, and more particularly, to a multifunctional timepiece with LED illuminating system.

### BACKGROUND OF THE INVENTION

As a time passage measurement instrument, timepieces have close relation with people's daily life, and timepiece manufacturing techniques have already become known among the public. Presently, it is a trend to develop low-energy-consumption, high precision and multifunctional timepieces. However, the prior art timepieces have the problem of failing to clearly display the time, the temperature value and the humidity value in a relatively dim room or in the night time having relatively weak light or having not any illuminating source, and the problem has not been well solved up to date.

### SUMMARY OF THE INVENTION

A primary object of the present invention is to provide a multifunctional timepiece that includes a set of light-emitting diode (LED) lights capable of providing supplementary illumination. The LED illuminating system in the timepiece provides supplementary light, allowing a user to accurately know the time, the temperature and the humidity from the timepiece even in the night time having relatively weak light or having not any illuminating source, so that the disadvantage of the existing timepieces is solved.

To achieve the above and other objects, the multifunctional timepiece with LED illuminating system according to a preferred embodiment of the present invention includes a case frame, a glass panel cover, a dial, a case back, a set of hands, a power supply, a circuit board, a circuit switch device, a movement, a movement cover, a main body of the timepiece, a set of LED lights, an LED light cover for each of the LED lights, and a light transmissible plate. The LED lights can be separately fixed to light holders that are spaced along a circumferential edge of the light transmissible plate, or be separately set in radially inward cavities that are formed along the circumferential edge of the light transmissible plate, or be directly fixed to the circumferential edge of the light transmissible plate by glue bonding. The light transmissible plate is provided with markers, which are consistent with those provided on the dial. The light transmissible plate is located above the dial, and the hands are located above the light transmissible plate. Each of the LED lights has a specifically shaped LED light cover. When the light emitted by the LED lights is projected onto the LED light covers, the light is scattered on the light transmissible plate, which is coated with a light-absorbing material. Then, the light is evenly transmitted to the dial, so that the markers on the light transmissible plate and the dial all can be clearly seen.

The movement is fixed to a base using movement nuts and movement washers to serve as a time passage measurement system of the timepiece. The movement is powered using a rechargeable battery, which can be an ordinary battery, a nickel-metal hydride (NiMH) battery, or a lithium (Li) battery. According to the preferred embodiment of the present invention, the movement is preferably powered using a #5 NiMH battery. To facilitate easy installation and hanging of the timepiece, the case frame can be provided with at least three holes and equipped with alloy accessories, hexagonal nuts and elastic washers. Also, the case back of the timepiece is provided with at least three holes, through which case back screws and case back nuts are extended to fix the case back to the case frame. Meanwhile, at least three springs can be provided between the case back and the case frame to buffer the pressure between the case back and the case frame.

The power supply system for the LED illuminating system includes at least one battery pack. According to the preferred embodiment of the present invention, two #1 battery packs are preferably used to power the LED illuminating system. The #1 battery packs along with battery holder spring plates and a circuit switch are fixed in between a battery holder A and a cover for the battery holder A, as well as in between a battery holder B and a cover for the battery holder B. According to the present invention, the control device can be a photosensitive control element or a manual control switch, and is electrically connected in series to an output circuit of the power supply. The battery holders can be made of a reinforced resin material, a fiber-reinforced plastic material (FRP), or an acrylonitrile butadiene styrene (ABS) material. According to the preferred embodiment of the present invention, an ABS material is preferably used to make the battery holders. To enhance the waterproof function of the timepiece, a sealing ring can be additionally provided between the glass panel cover and the case frame, and another sealing ring can be additionally provided in the movement cover.

The timepiece of the present invention can further internally include a thermometer, a hygrometer, a plurality of nuts and washers for locking the thermometer and the hygrometer in place, and pointers for the thermometer and the hygrometer, so that a temperature value and a humidity value can also be shown on the surface of the timepiece.

The light transmissible plate can be made of resin glass, tempered glass or common glass. The sealing rings can be made of a thermoplastic rubber (TPR) material. The case frame can be made of stainless steel, any alloy, wood, reinforced resin, FRP or an ABS material. The case frame of the timepiece can be round, elliptical or regular polygonal in shape.

With the present invention, it is able to solve the problem of unable to accurately read the time in the night time, in a dim room, or in the night time with relatively weak light or having not any illuminating source. Meanwhile, the timepiece of the present invention is a multifunctional timepiece, which shows time, temperature value and humidity value at the same time. With the LED illuminating system, the timepiece of the present invention can be used in the night time, in a dim room, or in the night time having relatively weak light or having not any illuminating source, allowing a user to accurately read the time, the temperature and the humidity at any time and place. With the sealing rings provided between the glass panel cover and the case frame and in the movement cover, the timepiece of the present invention provides enhanced moisture-proof and damp-proof functions.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front perspective view of a multifunctional timepiece with LED illuminating system according to the present invention;

FIG. 2 is a partially exploded view of the timepiece of FIG. 1;

FIG. 3 is a fully exploded view of the timepiece of FIG. 1;

FIG. 4 is a plan view of an LED light cover used in the timepiece of FIG. 1;

FIG. 5 is a sectional view taken along line A-A of FIG. 4;

FIG. 6 is a plan view of a battery holder used in the timepiece of FIG. 1;

FIG. 7 is a sectional view taken along line B-B of FIG. 6; and

FIG. 8 is a sectional view taken along line C-C of FIG. 6.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

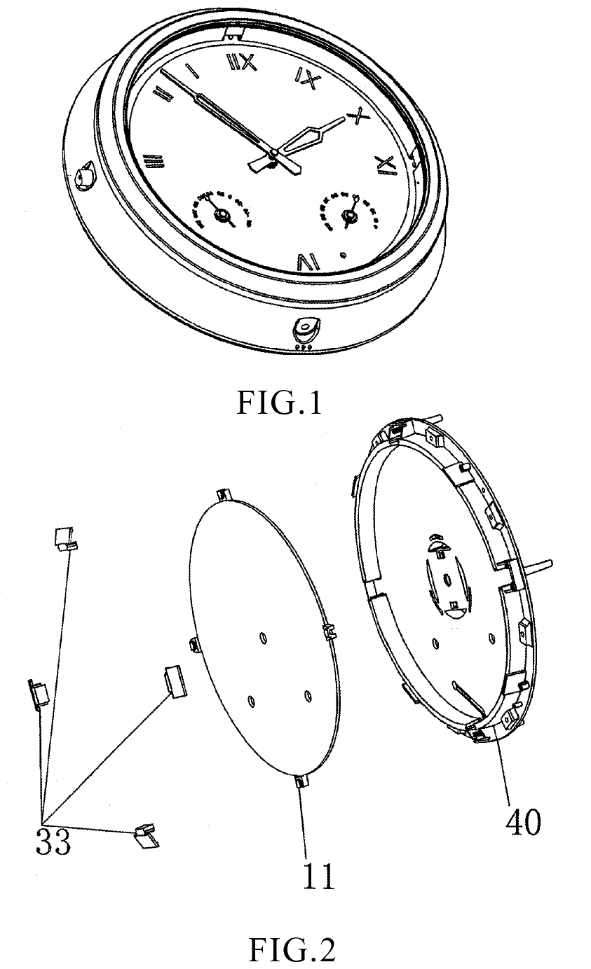

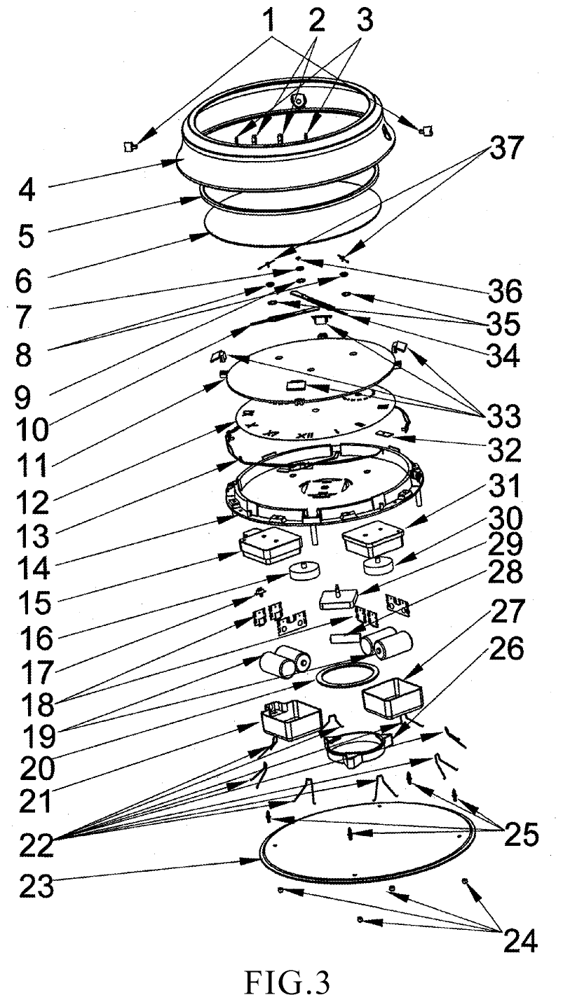

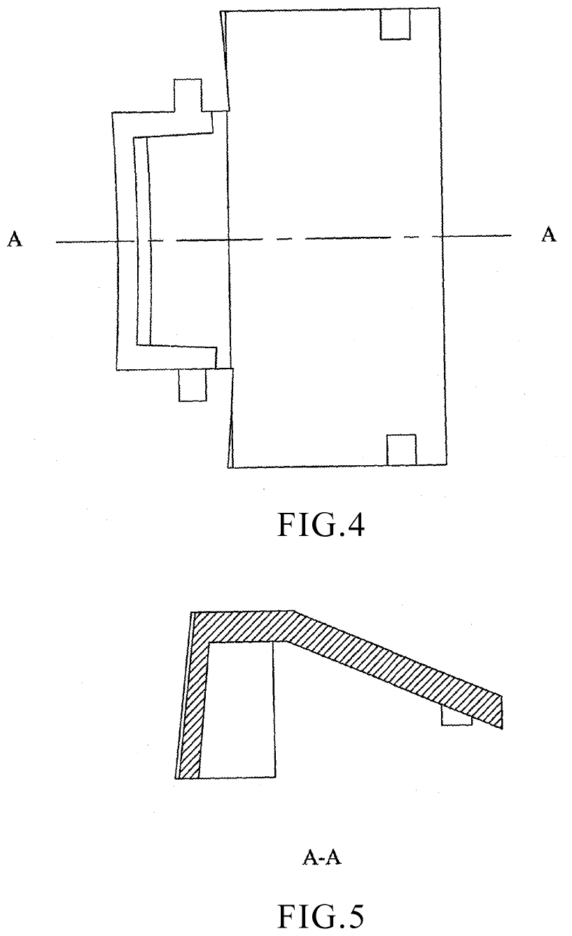

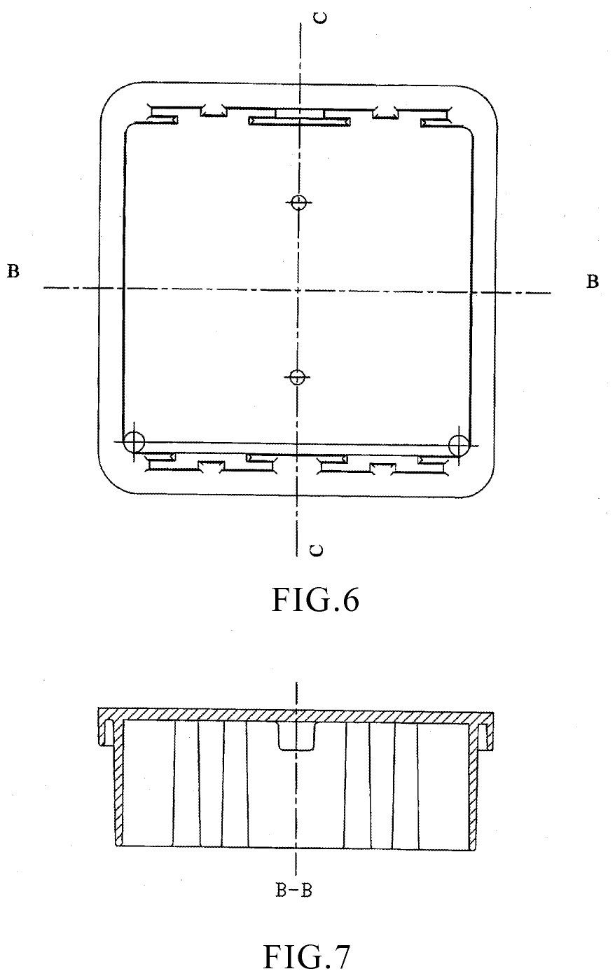

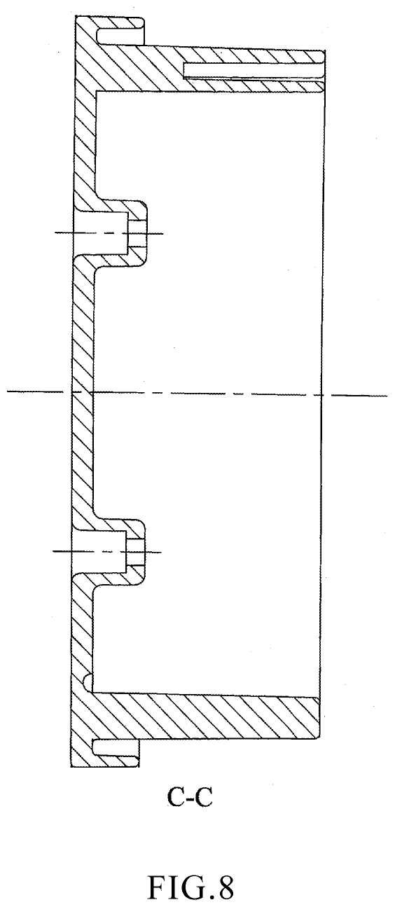

Please refer to FIGS. 1 to 8. A multifunctional timepiece with LED illuminating system according the present invention is shown. For the purpose of conciseness and clarity, the present invention is also briefly referred to as the timepiece herein. As shown, the timepiece of the present invention is a multifunctional timepiece that includes a set of light-emitting diode (LED) lights capable of providing supplementary illumination. The timepiece according to a first preferred embodiment of the present invention mainly includes a case frame 4, a movement 29, a set of hands, a dial 12, a main body 14 of the timepiece, a set of LED lights 13, a light transmissible plate 11, a power supply and a control device. The LED lights 13 are fixed in a plurality of light holders, which are spaced along a circumferential edge of the light transmissible plate 11. The light transmissible plate 11 is located above the dial 12, and the hands are located above the light transmissible plate 11.

The LED lights 13 have wires fixed to the main body 14 of the timepiece. The LED lights 13 are electrically connected in series and can be, for example, three (3) in number, and are therefore circumferentially equally spaced from one another by 120 degrees when being fixed in the light holders. The control device is a photosensitive control element electrically connected in series to an output circuit of the power supply. In a light insufficient environment, the circuit is closed and electric current is supplied from the power supply to the LED lights 13 for the latter to emit light; and the emitted light is projected onto the light transmissible plate 11. The light transmissible plate 11 is provided with markers, which are consistent with those provided on the dial 12. The light transmissible plate 11 is coated with a light-absorbing material. The light emitted by the LED lights 13 and projected onto the light transmissible plate 11 is then evenly projected onto the dial 12, so that the markers on the light transmissible plate 11 and the dial 12 all can be clearly seen, enabling a user to accurately know the time even in the night time or in a dim room or in the night time without any illumination. The movement 29 is fixed to a base 40 using movement nuts 7 and movement washers 9 to serve as a time passage measurement system of the timepiece. The movement 29 is powered using a rechargeable battery 28, which can be an ordinary battery, a nickel-metal hydride (NiMH) battery, or a lithium (Li) battery. According to the first preferred embodiment of the present invention, the movement 29 is preferably powered using a #5 NiMH battery. The case frame 4 can be round, elliptical or regular polygonal in shape, and can be made of a stainless steel material, an alloy, wood, a reinforced resin material, a fiber reinforced plastic (FRP) material, or an acrylonitrile butadiene styrene (ABS) material. According to the first preferred embodiment of the present invention, the case frame 4 is preferably made of a stainless steel material. To facilitate easy installation and hanging of the timepiece, the case frame 4 can be provided with at least three holes and equipped with alloy accessories 1, hexagonal nuts 2 and elastic washers 3. Also, a case back 23 of the timepiece is provided with at least three holes, through which case back screws 25 and case back nuts 24 are extended to fix the case back 23 to the case frame 4. Meanwhile, at least three springs can be provided between the case back 23 and the case frame 14 to buffer the pressure between the case back 23 and the case frame 14. A power supply system for the LED illuminating system includes at least one battery pack 19. According to the first preferred embodiment of the present invention, two #1 battery packs 19 are preferably used to power the LED illuminating system. The #1 battery packs 19 along with battery holder spring plates 18 and a circuit switch 17 are fixed in between a battery holder A 31 and a cover 27 for the battery holder A, as well as in between a battery holder B 15 and a cover 21 for the battery holder B. The battery holders can be made of a reinforced resin material, FRP, or an ABS material. According to the first preferred embodiment of the present invention, an ABS material is preferably used to make the battery holders. In another operable preferred embodiment of the present invention, the set of LED lights 13 includes four LED lights, which are electrically connected in series and 90-degree spaced along the circumferential edge of the light transmissible plate 11 and respectively located within an LED light cover. In a further operable preferred embodiment of the present invention, the control device is a manual control switch. When the switch is ON, the circuit is closed (connected) and the LED lights 13 are powered to emit light. When the switch is OFF, the circuit is opened (disconnected), and the LED lights 13 do not emit light. In a still further operable preferred embodiment of the present invention, the LED lights 13 are electrically connected in parallel and are evenly distributed in the light holders provided along the circumferential edge of the light transmissible plate 11. According to a still further operable preferred embodiment of the present invention, the LED lights 13 are evenly distributed in cavities radially inward formed along the circumferential edge of the light transmissible plate 11. According to a still further operable preferred embodiment of the present invention, the LED lights 13 are directly fixed to the circumferential edge of the light transmissible plate 11 by glue bonding.

In a multifunctional timepiece with LED illuminating system according to a second preferred embodiment of the present invention, the timepiece includes a case frame 4, a glass panel cover 6, a dial 12, a case back 23, a second hand 36, a minute hand 34, an hour hand 10, a plurality of battery packs 19, a circuit board 32, a circuit switch device 17, a movement 29, a movement cover 26, a main body 14 of the timepiece, a set of LED lights 13, a plurality of LED light covers 33, and a light transmissible plate 11. The main body 14 is located below the dial 12; the LED lights 13 are fixed to the main body 14; the light transmissible plate 11 is located above the dial 12; and the second hand 36, the minute hand 34 and the hour hand 10 are located above the light transmissible plate 11. A power supply system for the LED illuminating system includes at least one battery pack 19. In the second preferred embodiment, two #1 battery packs 19 are preferably used to power the LED illuminating system. The #1 battery packs 19 along with battery holder spring plates 18 and a circuit switch 17 are fixed in between a battery holder A 31 and a cover 27 for the battery holder A, as well as in between a battery holder B 15 and a cover 21 for the battery holder B. The timepiece according to the second preferred embodiment of the present invention further includes a thermometer 30, a hygrometer 16, a plurality of thermometer and hygrometer fixing nuts 8, a plurality of washers 35 for the thermometer and the hygrometer, and pointers 37 for the thermometer and the hygrometer. The LED lights 13 are fixed to the main body 14 and emit light when being powered by the power supply. A specifically configured LED light cover 33 is provided on a top of each of the LED lights 13. When the light emitted by the LED lights 13 is projected onto the LED light covers 33, the light is scattered on the light transmissible plate 11, which is coated with a light-absorbing material. Then, the light is evenly transmitted to the dial 12, so that the markers on the light transmissible plate 11 and the dial 12 all can be clearly seen, enabling a user to accurately read the time, the temperature value and the humidity value shown on the surface of the timepiece even in the night time with insufficient light or in a dim room with relatively weak light, or in the night time without any illumination.

According to a third preferred embodiment of the present invention, the multifunctional timepiece with LED illuminating system mainly includes a case frame 4, a movement 29, a set of hands, a dial 12, a main body 14 of the timepiece, a set of LED lights 13 and a light transmissible plate 11. The LED lights 13 are fixed to the light transmissible plate 11 and respectively located within an LED light cover; the light transmissible plate 11 is located above the dial 12; the hands are located above the light transmissible plate 11; and wires of the LED lights 13 are fixed to the main body 14 of the timepiece. In the third preferred embodiment, the LED lights 13 are three in number and electrically connected in series while they are seated in light holders, which are equally spaced along the circumferential edge of the light transmissible plate 11. The LED lights 13 emit light when they are powered by the power supply, and the emitted light is scattered on the light transmissible plate 11, which is coated with a light-absorbing material. Then, the light is evenly transmitted to the dial 12, so that the markers on the light transmissible plate 11 and the dial 12 all can be clearly seen. In the third preferred embodiment, a rubber sealing ring 5 is additionally provided between the glass panel cover 6 and the case frame 4 and another sealing ring 20 is additionally provided in the movement cover 26, in order to prevent moisture from entering into the timepiece via the glass panel cover 6 and the movement cover 26. With these arrangements, the timepiece according to the present invention is damp-proof and moisture-proof to effectively extend the service life of parts inside the timepiece, particularly the parts for the movement 29.

The present invention has been described with some preferred embodiments thereof and it is understood that the preferred embodiments are only illustrative and not intended to limit the present invention in any way and many changes and modifications in the described embodiments can be carried out by a person of ordinary skill in the art without departing from the scope and the spirit of the invention that is intended to be limited only by the appended claims.

What is claimed is:

1. A multifunctional timepiece with LED illuminating system, comprising a case frame, a movement, a set of hands, a dial and a main body of the timepiece, characterized in that, a set of LED lights, a light transmissible plate, a power supply and a control device are further included in the timepiece; and the LED lights being fixed to a circumferential edge of the light transmissible plate, the light transmissible plate being located above the dial, the hands being located above the light transmissible plate, and the light transmissible plate being provided with markers, which are consistent with those provided on the dial.

2. The multifunctional timepiece with LED illuminating system as claimed in claim 1, characterized in that the set of LED lights includes at least three LED lights, which are equally spaced along the circumferential edge of the light transmissible plate and electrically connected to a set of wires in series or in parallel.

3. The multifunctional timepiece with LED illuminating system as claimed in claim 1, characterized in that the light transmissible plate is provided along the circumferential edge with radially inward cavities, and the LED lights being set in the cavities.

4. The multifunctional timepiece with LED illuminating system as claimed in claim 2, characterized in that the light transmissible plate is provided along the circumferential edge with radially inward cavities, and the LED lights being set in the cavities.

5. The multifunctional timepiece with LED illuminating system as claimed in claim 1, characterized in that the light transmissible plate is provided along the circumferential edge with fixedly mounted light holders, and the LED lights being seated in the light holders.

6. The multifunctional timepiece with LED illuminating system as claimed in claim 2, characterized in that the light transmissible plate is provided along the circumferential edge with fixedly mounted light holders, and the LED lights being seated in the light holders.

7. The multifunctional timepiece with LED illuminating system as claimed in claim 1, characterized in that the LED lights are fixed to the circumferential edge of the light transmissible plate by glue bonding.

8. The multifunctional timepiece with LED illuminating system as claimed in claim 2, characterized in that the LED lights are fixed to the circumferential edge of the light transmissible plate by glue bonding.

9. The multifunctional timepiece with LED illuminating system as claimed in claim 1, characterized in that the control device is a photosensitive control element electrically connected in series to an output circuit of the power supply.

10. The multifunctional timepiece with LED illuminating system as claimed in claim 2, characterized in that the control device is a photosensitive control element electrically connected in series to an output circuit of the power supply.

11. The multifunctional timepiece with LED illuminating system as claimed in claim 1, characterized in that the control device is a manual control switch electrically connected in series to an output circuit of the power supply.

12. The multifunctional timepiece with LED illuminating system as claimed in claim 2, characterized in that the control device is a manual control switch electrically connected in series to an output circuit of the power supply.

13. The multifunctional timepiece with LED illuminating system as claimed in claim 1, characterized in that the timepiece further comprises a thermometer and a hygrometer; the thermometer being located within the case frame, and the hygrometer also being located within the case frame.

14. The multifunctional timepiece with LED illuminating system as claimed in claim 2, characterized in that the timepiece further comprises a thermometer and a hygrometer; the thermometer being located within the case frame, and the hygrometer also being located within the case frame.

15. The multifunctional timepiece with LED illuminating system as claimed in claim 1, characterized in that the timepiece further comprises a sealing ring provided between the case frame and a glass panel cover of the case frame, and another sealing ring provided in a back cover of the movement.

16. The multifunctional timepiece with LED illuminating system as claimed in claim 2, characterized in that the timepiece further comprises a sealing ring provided between the case frame and a glass panel cover of the case frame, and another sealing ring provided in a back cover of the movement.

17. The multifunctional timepiece with LED illuminating system as claimed in claim 1, characterized in that case frame can be round, elliptical or regular polygonal in shape.

18. The multifunctional timepiece with LED illuminating system as claimed in claim 2, characterized in that case frame can be round, elliptical or regular polygonal in shape.
